(19) United States
(12) Patent Application Publication
(10) Pub. No.: US 2018/0350507 A1
(43) Pub. Date: Dec. 6, 2018

(54) LAMINATED TRANSFORMER AND METHOD FOR MANUFACTURING LAMINATED TRANSFORMER

(71) Applicant: FDK CORPORATION, Tokyo (JP)

(72) Inventors: Daisuke MATSUBAYASHI, Tokyo (JP); Mikio KITAOKA, Tokyo (JP); Kiyohisa YAMAUCHI, Tokyo (JP); Minako SUZUKI, Tokyo (JP)

(73) Assignee: FDK CORPORATION, Tokyo (JP)

(21) Appl. No.: 16/055,632

(22) Filed: Aug. 6, 2018

Related U.S. Application Data
(63) Continuation of application No. PCT/JP2016/086911, filed on Dec. 12, 2016.

(30) Foreign Application Priority Data
Feb. 9, 2016 (JP) 2016-022367

(51) Int. Cl. H01F 27/28; H01F 17/00; H01F 17/04; H01F 41/04

(52) U.S. Cl. CPC H01F 27/2804; H01F 17/0013; H01F 2027/2809; H01F 41/043; H01F 41/046; H01F 17/04

(57) ABSTRACT

A laminated transformer includes a magnetic substance layer, a coil lamination stacked on the magnetic substance layer, the coil lamination having formed thereinside a primary coil and a secondary coil, the primary coil being wound spirally in convolutions in a stacking direction, the secondary coil being wound spirally in convolutions in the stacking direction and formed inside the primary coil, a magnetic substance filling inside of the secondary coil in the coil lamination, and a non-magnetic substance filling a region between the primary coil and the secondary coil and filling outside of the primary coil in the coil lamination.

### CROSS-REFERENCE TO RELATED APPLICATION

This application is a continuation of International Application No. PCT/JP2016/086911, filed on Dec. 12, 2016, which claims the benefit of priority from Japanese Patent Application No. 2016-022367 filed on Feb. 9, 2016, the entire contents of which are incorporated herein by reference.

### FIELD

The present disclosure relates to a laminated transformer and a method for manufacturing a laminated transformer.

### BACKGROUND

Traditional transformers commonly incorporate a structure in which a coil is wound on a magnetic core. This structure has made it difficult to achieve reduction in size, particularly in height. To achieve reduction in size and height, therefore, a recent trend is toward development of a transformer having a laminated structure (specifically, a laminated transformer).

Examples of related-art are described in Japanese Patent Application Laid-open Patent Publication No. 2013-247155.

The traditional laminated transformers, because of a weak coupling between a primary coil and a secondary coil, have had difficulty in achieving properties required for transformers.

### SUMMARY

According to an aspect of an embodiment, a laminated transformer includes a magnetic substance layer, a coil lamination stacked on the magnetic substance layer, the coil lamination having formed thereinside a primary coil and a secondary coil, the primary coil being wound spirally in convolutions in a stacking direction, the secondary coil being wound spirally in convolutions in the stacking direction and formed inside the primary coil, a magnetic substance filling inside of the secondary coil in the coil lamination, and a non-magnetic substance filling a region between the primary coil and the secondary coil and filling outside of the primary coil in the coil lamination.

The object and advantages of the disclosure will be realized and attained by means of the elements and combinations particularly pointed out in the claims.

It is to be understood that both the foregoing general description and the following detailed description are exemplary and explanatory and are not restrictive of the disclosure, as claimed.

### BRIEF DESCRIPTION OF DRAWINGS

FIG. 1 is a diagram illustrating an exemplary construction of a laminated transformer in one embodiment.

FIG. 2 is an exploded perspective view of the laminated transformer in one embodiment.

FIG. 3 is a diagram illustrating an exemplary print pattern in one embodiment.

FIG. 4 is a diagram illustrating an exemplary print pattern in one embodiment.

FIG. 5 is a diagram illustrating an exemplary print pattern in one embodiment.

FIG. 6 is a diagram illustrating an exemplary print pattern in one embodiment.

FIG. 7 is a diagram illustrating an exemplary print pattern in one embodiment.

FIG. 8 is a diagram illustrating an exemplary print pattern in one embodiment.

FIG. 9 is a diagram illustrating an exemplary print pattern in one embodiment.

FIG. 10 is a diagram illustrating an exemplary print pattern in one embodiment.

FIG. 11 is a diagram illustrating an exemplary print pattern in one embodiment.

FIG. 12 is a diagram illustrating an exemplary print pattern in one embodiment.

### DESCRIPTION OF EMBODIMENTS

Preferred embodiments of the present disclosure will be explained with reference to accompanying drawings. In the embodiment to be described below, like reference numerals are assigned to like elements.

Construction of Laminated Transformer

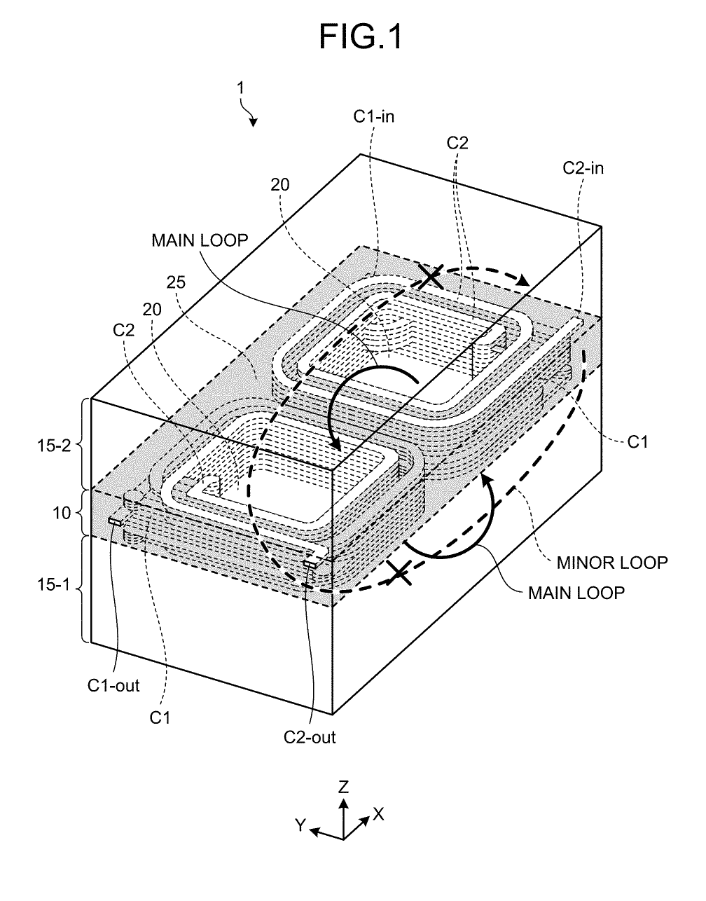

FIG. 1 is a diagram illustrating an exemplary construction of a laminated transformer in one embodiment. This laminated transformer 1 illustrated in FIG. 1 includes magnetic substance layers 15-1 and 15-2, and a coil lamination 10. The magnetic substance layers 15-1 and 15-2, and the coil lamination 10 are stacked one on top of another such that the coil lamination 10 is sandwiched between the magnetic substance layers 15-1 and 15-2. In the following, the magnetic substance layer 15-1 and the magnetic substance layer 15-2, when they are not differentiated from each other, may be collectively referred to as a magnetic substance layer 15. The magnetic substance layer 15 is made of, for example, a magnetic ferrite material.

Inside the coil lamination 10, formed is a primary coil C1 being wound spirally in convolutions in a Z-direction (specifically, a stacking direction). Inside the coil lamination 10, formed is a secondary coil C2 being wound spirally in convolutions in the Z-direction. In the coil lamination 10, two primary coils C1 are formed in juxtaposition in an X-direction and two secondary coils C2 are formed in juxtaposition in the X-direction. The two primary coils C1 juxtaposed to each other in the X-direction are connected with each other at, for example, a position near a middle in the Z-direction in the coil lamination 10. The two secondary coils C2 juxtaposed to each other in the X-direction are connected with each other at, for example, a lowest portion in the Z-direction in the coil lamination 10. The primary coil C1 and the secondary coil C2 are formed of, for example, silver.

The primary coil C1 is wound in a direction opposition to a direction in which the secondary coil C2 is wound. At a location at which the primary coil C1 exists in the coil lamination 10, the secondary coil C2 is formed inside the primary coil C1.

The primary coil C1 has an input end C1-in and the secondary coil C2 has an input end C2-in disposed, for example, on one identical lateral face out of four lateral faces of the coil lamination 10. The primary coil C1 has an output end C1-out and the secondary coil C2 has an output end C2-out disposed, for example, on, out of the four lateral faces of the coil lamination 10, an identical lateral face facing the lateral face on which the input ends C1-in and C2-in are disposed.

The inside of the secondary coil C2 in the coil lamination 10 is filled with a magnetic substance 20. The magnetic substance 20 filling the inside of the secondary coil C2 is made of, for example, a magnetic ferrite material.

The space between the primary coil C1 and the secondary coil C2 in the coil lamination 10 is filled with a non-magnetic substance 25. The outside of the primary coil C1 in the coil lamination 10 is also filled with the non-magnetic substance 25. The outside of the primary coil C1 in the coil lamination 10 being filled with the non-magnetic substance 25 results in the non-magnetic substance 25 forming the lateral faces of the coil lamination 10. The non-magnetic substance 25 is made of, for example, a non-magnetic ferrite material.

The coil lamination 10 described above is manufactured through a laminated transformer manufacturing method to be described below.

When current flows from the input end C1-in toward the output end C1-out in the laminated transformer 1, a “main loop” as a required magnetic flux that generates current flowing from the input end C2-in toward the output end C2-out occurs. The main loop circulates in the laminated transformer 1 through the insides of the primary coil C1 and the secondary coil C2.

Meanwhile, a region between the primary coil C1 and the secondary coil C2 (that may hereinafter be referred to as a “first region”) and a region outside the primary coil C1 (that may hereinafter be referred to as a “second region”) in the coil lamination 10 are filled with the non-magnetic substance 25. Thus, a “minor loop” as an unnecessary magnetic flux that circulates in the laminated transformer 1 through the outsides of the primary coil C1 and the secondary coil C2 is intercepted by the non-magnetic substance 25 filling the first region and the second region. Specifically, filling the first region and the second region with the non-magnetic substance 25 can prevent the minor loop from occurring. The minor loop serves as a disturbance to the main loop, causing coupling between the primary coil C1 and the secondary coil C2 to be reduced. Thus, by preventing the minor loop from occurring, the coupling between the primary coil C1 and the secondary coil C2 can be increased as compared with a case in which the minor loop occurs.

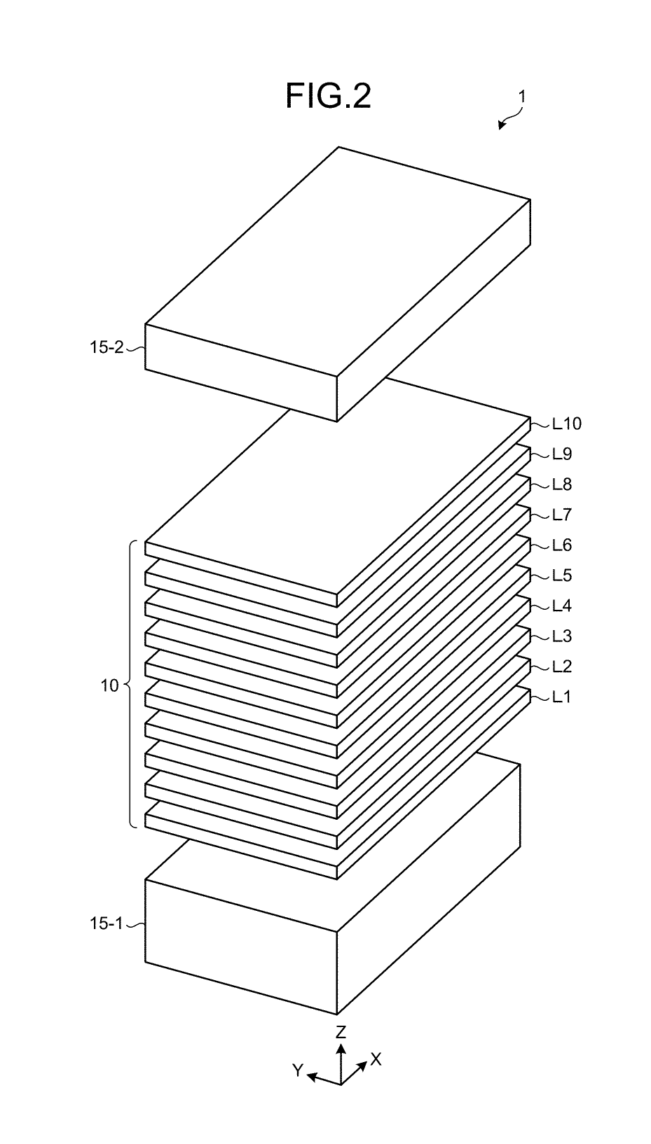

FIG. 2 is an exploded perspective view of the laminated transformer in one embodiment. As illustrated in FIG. 2, the coil lamination 10 in the laminated transformer 1 includes a plurality of layers including an L1 layer that constitutes a bottom face of the coil lamination 10 and an L10 layer that constitutes a top face of the coil lamination 10. Specifically, the coil lamination 10 has a laminated structure in which the layers from the L1 layer to the L10 layer are stacked one on top of another in the Z-direction. Each of the layers from the L1 layer through the L10 layer has an identical thickness. Additionally, the laminated transformer 1 has a laminated structure in which the magnetic substance layer 15-1, the coil lamination 10, and the magnetic substance layer 15-2 are stacked in sequence in the Z-direction. When the laminated transformer 1 is viewed in a thickness direction (specifically, Z-direction), each of the L1 layer to the L10 layer has an identical thickness.

Laminated Transformer Manufacturing Method

In the coil lamination 10, the primary coil C1, the secondary coil C2, the magnetic substance 20 filling the inside of the secondary coil C2, the non-magnetic substance 25 filling the region between the primary coil C1 and the secondary coil C2, and the non-magnetic substance 25 filling the outside of the primary coil C1 are formed by screen printing into a coil pattern (specifically, conductor pattern), a magnetic pattern, and a non-magnetic pattern, respectively, as follows. Thus, the layers from the L1 layer through the L10 layer correspond to “print pattern layers” that represent the coil pattern, the magnetic pattern, and the non-magnetic pattern formed by screen printing. The print pattern layers are stacked on top of the magnetic substance layer 15-1 as illustrated in FIG. 2. For example, the coil pattern is formed by screen printing of paste-like silver, the magnetic pattern is formed by screen printing of paste-like magnetic ferrite, and the non-magnetic pattern is formed by screen printing of paste-like non-magnetic ferrite.

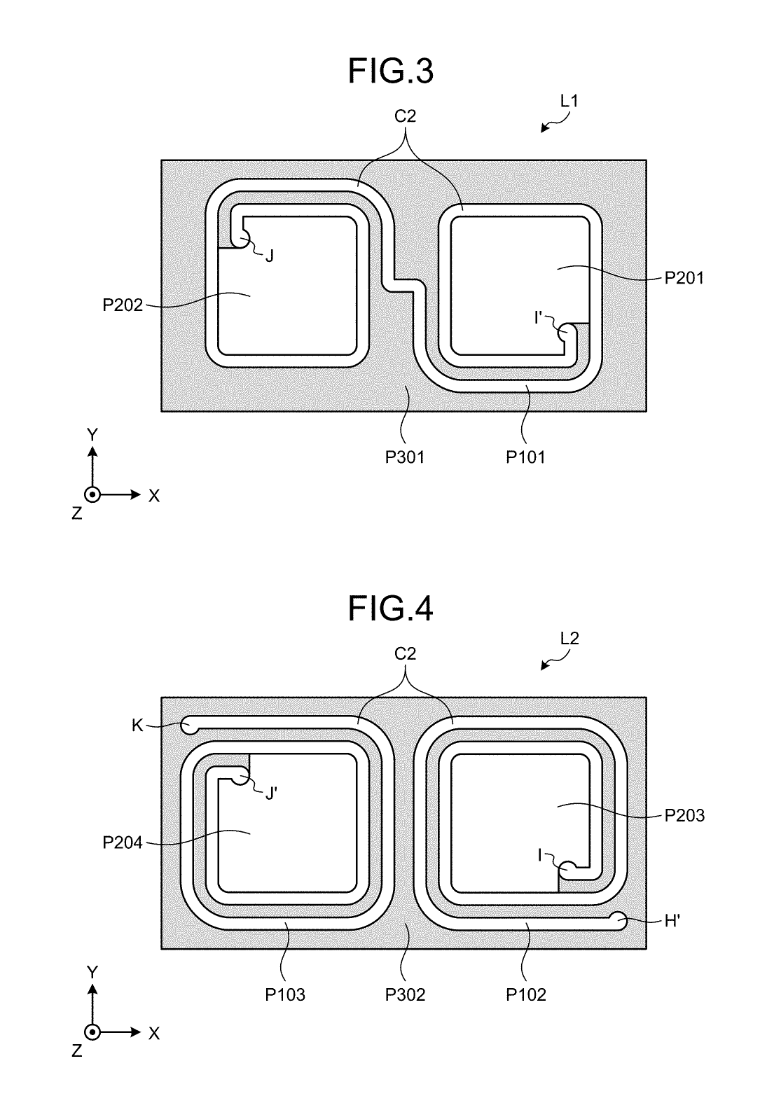

FIGS. 3 to 12 are each a diagram illustrating an exemplary print pattern in one embodiment. Each of the layers from the L1 layer through the L10 layer illustrated in FIGS. 3 to 12 is screen-printed over the magnetic substance layer 15-1, starting with the L1 layer in sequence. Specifically, the L1 layer corresponds to a bottom layer of the coil lamination 10 and the L10 layer corresponds to a top layer of the coil lamination 10.

As illustrated in FIG. 3, the L1 layer includes a coil pattern P101, magnetic patterns P201 and P202, and a non-magnetic pattern P301 that are formed by screen printing. The coil pattern P101 represents a coil pattern of the secondary coil C2. In the L1 layer, the magnetic patterns P201 and P202 are formed in all regions inside the coil pattern P101 and the non-magnetic pattern P301 is formed in all regions except for the coil pattern P101 and the magnetic patterns P201 and P202. In addition, the two secondary coils C2 juxtaposed in the X-direction are connected with each other in the L1 layer.

When the L1 layer is viewed in a thickness direction, each of the magnetic patterns P201 and P202 and the non-magnetic pattern P301 has a thickness identical to a thickness of the L1 layer and the coil pattern P101 has a thickness thinner than the thickness of the L1 layer. Additionally, the coil pattern P101 has an upper face flush with upper faces of the magnetic patterns P201 and P202 and an upper face of the non-magnetic pattern P301.

As illustrated in FIG. 4, the L2 layer includes coil patterns P102 and P103, magnetic patterns P203 and P204, and a non-magnetic pattern P302 that are formed by screen printing. The coil patterns P102 and P103 each represent a coil pattern of the secondary coil C2. In the L2 layer, the magnetic pattern P203 is formed in an entire region inside the coil pattern P102, the magnetic pattern P204 is formed in an entire region inside the coil pattern P103, and the non-magnetic pattern P302 is formed in all regions except for the coil patterns P102 and P103 and the magnetic patterns P203 and P204.

When the L2 layer is viewed in the thickness direction, each of the magnetic patterns P203 and P204 and the non-magnetic pattern P302 has a thickness identical to a thickness of the L2 layer and each of the coil patterns P102 and P103 has a thickness thinner than the thickness of the L2 layer. Additionally, the coil patterns P102 and P103 each have an upper face flush with upper faces of the magnetic patterns P203 and P204 and an upper face of the non-magnetic pattern P302.

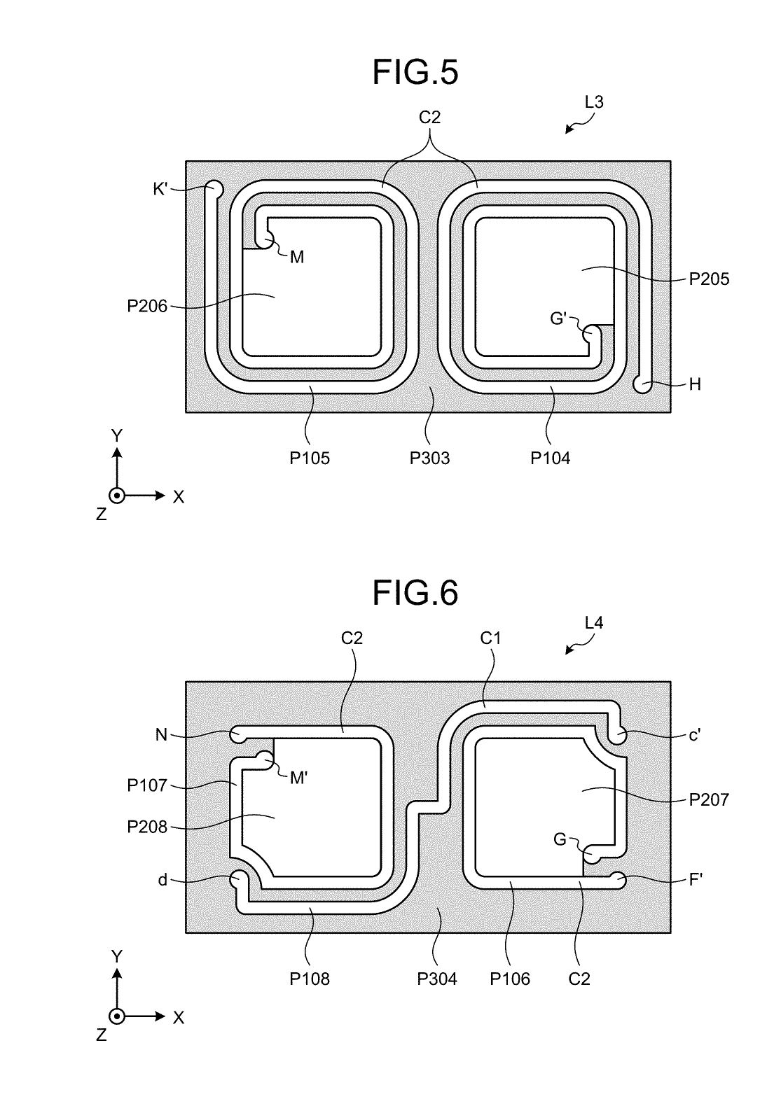

As illustrated in FIG. 5, the L3 layer includes coil patterns P104 and P105, magnetic patterns P205 and P206, and a non-magnetic pattern P303 that are formed by screen printing. The coil patterns P104 and P105 each represent a coil pattern of the secondary coil C2. In the L3 layer, the magnetic pattern P205 is formed in an entire region inside the coil pattern P104, the magnetic pattern P206 is formed in an entire region inside the coil pattern P105, and the non-magnetic pattern P303 is formed in all regions except for the coil patterns P104 and P105 and the magnetic patterns P205 and P206.

When the L3 layer is viewed in the thickness direction, each of the magnetic patterns P205 and P206 and the non-magnetic pattern P303 has a thickness identical to a thickness of the L3 layer and each of the coil patterns P104 and P105 has a thickness thinner than the thickness of the L3 layer. Additionally, the coil patterns P104 and P105 each have an upper face flush with upper faces of the magnetic patterns P205 and P206 and an upper face of the non-magnetic pattern P303.

As illustrated in FIG. 6, the L4 layer includes coil patterns P106, P107, and P108, magnetic patterns P207 and P208, and a non-magnetic pattern P304 that are formed by screen printing. The coil pattern P108 represents a coil pattern of the primary coil C1 and the coil patterns P106 and P107 each represent a coil pattern of the secondary coil C2. In the L4 layer, the two primary coils C1 juxtaposed in the X-direction are connected with each other. The L4 layer corresponds to a middle layer in the coil lamination 10. In the L4 layer, the magnetic pattern P207 is formed in an entire region inside the coil pattern P106, the magnetic pattern P208 is formed in an entire region inside the coil pattern P107, and the non-magnetic pattern P304 is formed in all regions except for the coil patterns P106, P107, and P108 and the magnetic patterns P207 and P208.

When the L4 layer is viewed in the thickness direction, each of the magnetic patterns P207 and P208 and the non-magnetic pattern P304 has a thickness identical to a thickness of the L4 layer and each of the coil patterns P106, P107, and P108 has a thickness thinner than the thickness of the L4 layer. Additionally, the coil patterns P106, P107, and P108 each have an upper face flush with upper faces of the magnetic patterns P207 and P208 and an upper face of the non-magnetic pattern P304.

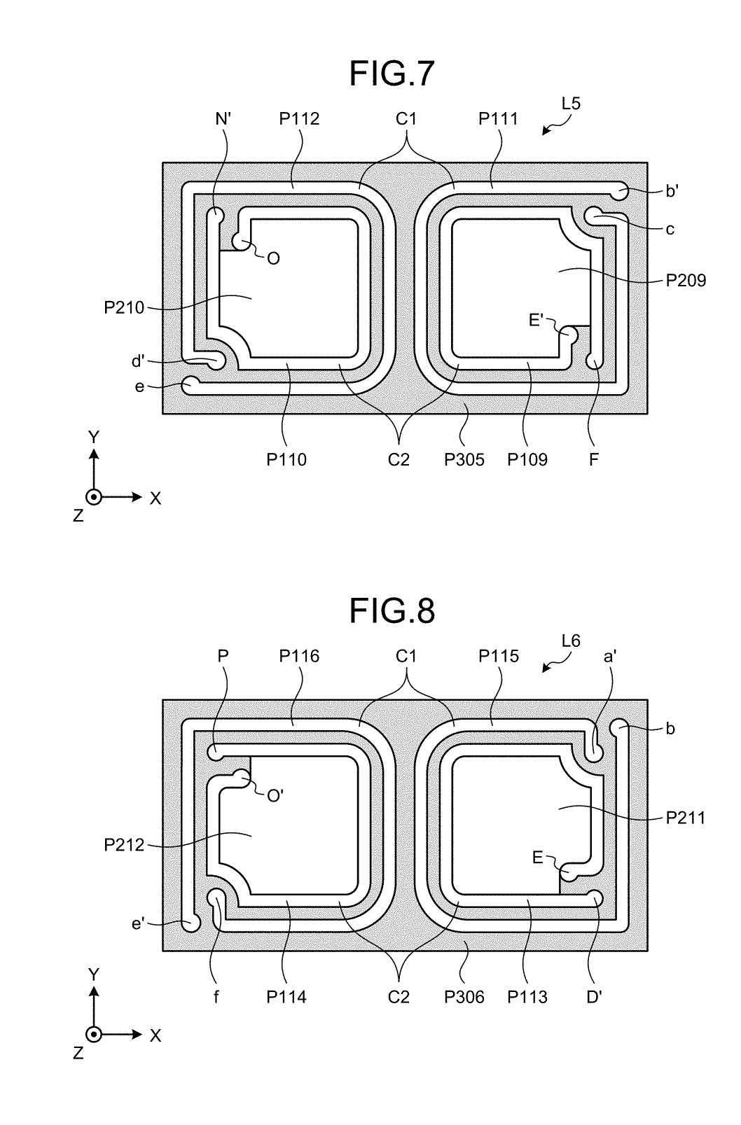

As illustrated in FIG. 7, the L5 layer includes coil patterns P109, P110, P111, and P112, magnetic patterns P209 and P210, and a non-magnetic pattern P305 that are formed by screen printing. The coil patterns P111 and P112 each represent a coil pattern of the primary coil C1 and the coil patterns P109 and P110 each represent a coil pattern of the secondary coil C2. In the L5 layer, the magnetic pattern P209 is formed in an entire region inside the coil pattern P109, the magnetic pattern P210 is formed in an entire region inside the coil pattern P110, and the non-magnetic pattern P305 is formed in all regions except for the coil patterns P109, P110, P111, and P112 and the magnetic patterns P209 and P210. Specifically, in the L5 layer, the non-magnetic pattern P305 is formed in the region between the coil patterns P109 and P111, the region between the coil patterns P110 and P112, the region outside the coil pattern P111, and the region outside the coil pattern P112.

When the L5 layer is viewed in the thickness direction, each of the magnetic patterns P209 and P210 and the non-magnetic pattern P305 has a thickness identical to a thickness of the L5 layer and each of the coil patterns P109, P110, P111, and P112 has a thickness thinner than the thickness of the L5 layer. Additionally, the coil patterns P109, P110, P111, and P112 each have an upper face flush with upper faces of the magnetic patterns P209 and P210 and an upper face of the non-magnetic pattern P305.

As illustrated in FIG. 8, the L6 layer includes coil patterns P113, P114, P115, and P116, magnetic patterns P211 and P212, and a non-magnetic pattern P306 that are formed by screen printing. The coil patterns P115 and P116 each represent a coil pattern of the primary coil C1 and the coil patterns P113 and P114 each represent a coil pattern of the secondary coil C2. In the L6 layer, the magnetic pattern P211 is formed in an entire region inside the coil pattern P113, the magnetic pattern P212 is formed in an entire region inside the coil pattern P114, and the non-magnetic pattern P306 is formed in all regions except for the coil patterns P113, P114, P115, and P116 and the magnetic patterns P211 and P212. Specifically, in the L6 layer, the non-magnetic pattern P306 is formed in the region between the coil patterns P113 and P115, the region between the coil patterns P114 and P116, the region outside the coil pattern P115, and the region outside the coil pattern P116.

When the L6 layer is viewed in the thickness direction, each of the magnetic patterns P211 and P212 and the non-magnetic pattern P306 has a thickness identical to a thickness of the L6 layer and each of the coil patterns P113, P114, P115, and P116 has a thickness thinner than the thickness of the L6 layer. Additionally, the coil patterns P113, P114, P115, and P116 each have an upper face flush with upper faces of the magnetic patterns P211 and P212 and an upper face of the non-magnetic pattern P306.

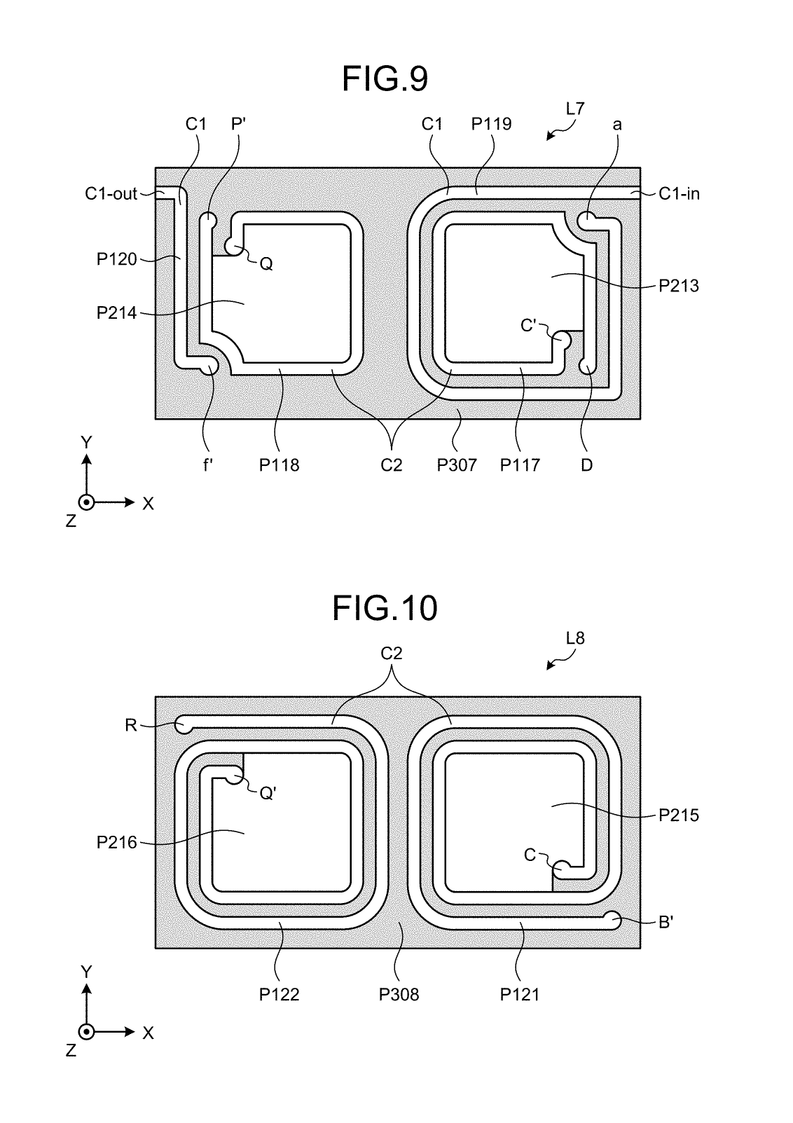

As illustrated in FIG. 9, the L7 layer includes coil patterns P117, P118, P119, and P120, magnetic patterns P213 and P214, and a non-magnetic pattern P307 that are formed by screen printing. The coil patterns P119 and P120 each represent a coil pattern of the primary coil C1 and the coil patterns P117 and P118 each represent a coil pattern of the secondary coil C2. In the L7 layer, the magnetic pattern P213 is formed in an entire region inside the coil pattern P117, the magnetic pattern P214 is formed in an entire region inside the coil pattern P118, and the non-magnetic pattern P307 is formed in all regions except for the coil patterns P117, P118, P119, and P120 and the magnetic patterns P213 and P214. Specifically, in the L7 layer, the non-magnetic pattern P307 is formed in the region between the coil patterns P117 and P119, the region between the coil patterns P118 and P120, the region outside the coil pattern P119, and the region outside the coil pattern P120. In addition, the L7 layer has formed therein the input end C1-in of the primary coil C1 and the output end C1-out of the primary coil C1. Specifically, the primary coil C1 has the input end C1-in and the output end C1-out formed on an identical layer.

When the L7 layer is viewed in the thickness direction, each of the magnetic patterns P213 and P214 and the non-magnetic pattern P307 has a thickness identical to a thickness of the L7 layer and each of the coil patterns P117, P118, P119, and P120 has a thickness thinner than the thickness of the L7 layer. Additionally, the coil patterns P117, P118, P119, and P120 each have an upper face flush with upper faces of the magnetic patterns P213 and P214 and an upper face of the non-magnetic pattern P307.

As illustrated in FIG. 10, the L8 layer includes coil patterns P121 and P122, magnetic patterns P215 and P216, and a non-magnetic pattern P308 that are formed by screen printing. The coil patterns P121 and P122 each represent a coil pattern of the secondary coil C2. In the L8 layer, the magnetic pattern P215 is formed in an entire region inside the coil pattern P121, the magnetic pattern P216 is formed in an entire region inside the coil pattern P122, and the non-magnetic pattern P308 is formed in all regions except for the coil patterns P121 and P122 and the magnetic patterns P215 and P216.

When the L8 layer is viewed in the thickness direction, each of the magnetic patterns P215 and P216 and the non-magnetic pattern P308 has a thickness identical to a thickness of the L8 layer and each of the coil patterns P121 and P122 has a thickness thinner than the thickness of the L8 layer. Additionally, the coil patterns P121 and P122 each have an upper face flush with upper faces of the magnetic patterns P215 and P216 and an upper face of the non-magnetic pattern P308.

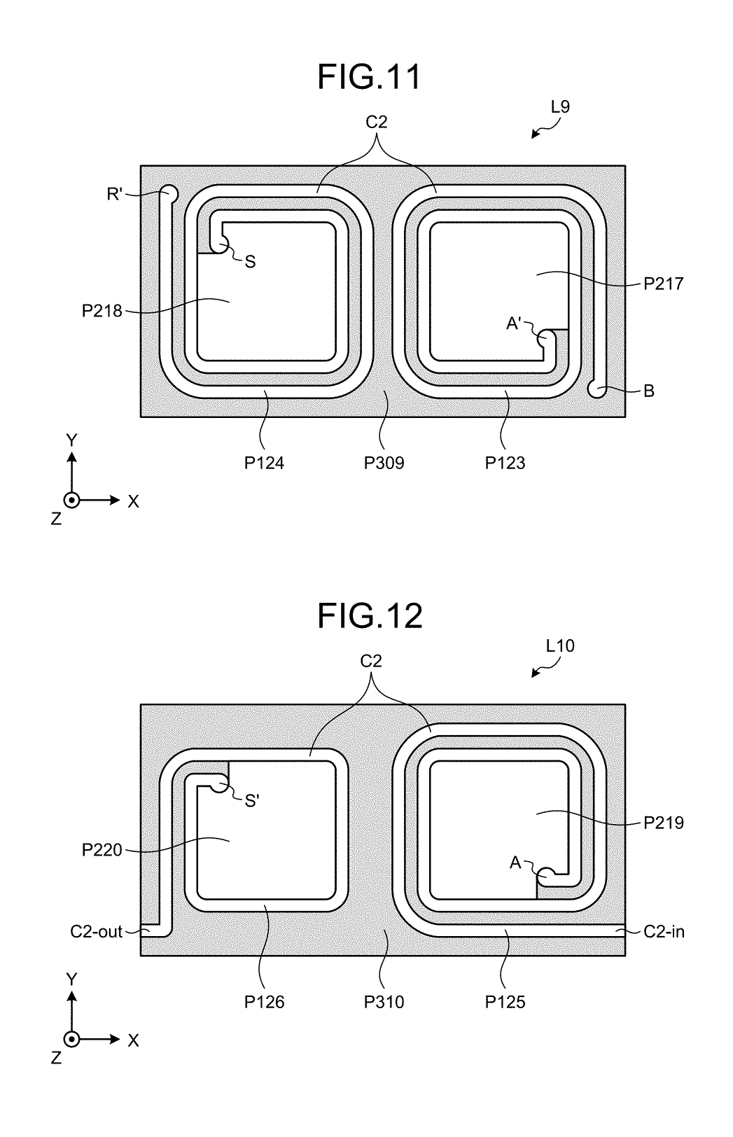

As illustrated in FIG. 11, the L9 layer includes coil patterns P123 and P124, magnetic patterns P217 and P218, and a non-magnetic pattern P309 that are formed by screen printing. The coil patterns P123 and P124 each represent a coil pattern of the secondary coil C2. In the L9 layer, the magnetic pattern P217 is formed in an entire region inside the coil pattern P123, the magnetic pattern P218 is formed in an entire region inside the coil pattern P124, and the non-magnetic pattern P309 is formed in all regions except for the coil patterns P123 and P124 and the magnetic patterns P217 and P218.

When the L9 layer is viewed in the thickness direction, each of the magnetic patterns P217 and P218 and the non-magnetic pattern P309 has a thickness identical to a thickness of the L9 layer and each of the coil patterns P123 and P124 has a thickness thinner than the thickness of the L9 layer. Additionally, the coil patterns P123 and P124 each have an upper face flush with upper faces of the magnetic patterns P217 and P218 and an upper face of the non-magnetic pattern P309.

As illustrated in FIG. 12, the L10 layer includes coil patterns P125 and P126, magnetic patterns P219 and P220, and a non-magnetic pattern P310 that are formed by screen printing. The coil patterns P125 and P126 each represent a coil pattern of the secondary coil C2. In the L10 layer, the magnetic pattern P219 is formed in an entire region inside the coil pattern P125, the magnetic pattern P220 is formed in an entire region inside the coil pattern P126, and the non-magnetic pattern P310 is formed in all regions except for the coil patterns P125 and P126 and the magnetic patterns P219 and P220. In addition, the L10 layer has formed therein the input end C2-in of the secondary coil C2 and the output end C2-out of the secondary coil C2. Specifically, the secondary coil C2 has the input end C2-in and the output end C2-out formed on an identical layer.

When the L10 layer is viewed in the thickness direction, each of the magnetic patterns P219 and P220 and the non-magnetic pattern P310 has a thickness identical to a thickness of the L10 layer and each of the coil patterns P125 and P126 has a thickness thinner than the thickness of the L10 layer. Additionally, the coil patterns P125 and P126 each have an upper face flush with upper faces of the magnetic patterns P219 and P220 and an upper face of the non-magnetic pattern P310.

Between the L1 layer (FIG. 3) and the L2 layer (FIG. 4), interlayer connections made between an end J and an end J′ and between an end I′ and an end I result in an interlayer connection being established between the coil pattern P101 and the coil patterns P102, P103. The interlayer connection between the ends is achieved via a via conductor.

Additionally, between the L2 layer (FIG. 4) and the L3 layer (FIG. 5), an interlayer connection made between an end H′ and an end H results in an interlayer connection being established between the coil pattern P102 and the coil pattern P104, and an interlayer connection made between an end K and an end K′ results in an interlayer connection being established between the coil pattern P103 and the coil pattern P105.

Additionally, between the L3 layer (FIG. 5) and the L4 layer (FIG. 6), an interlayer connection made between an end G′ and an end G results in an interlayer connection being established between the coil pattern P104 and the coil pattern P106, and an interlayer connection made between an end M and an end M′ results in an interlayer connection being established between the coil pattern P105 and the coil pattern P107.

Additionally, between the L4 layer (FIG. 6) and the L5 layer (FIG. 7), an interlayer connection made between an end F′ and an end F results in an interlayer connection being established between the coil pattern P106 and the coil pattern P109, an interlayer connection made between an end N and an end N′ results in an interlayer connection being established between the coil pattern P107 and the coil pattern P110, and an interlayer connections made between an end c′ and an end c, and between an end d and an end d′ result in an interlayer connection being established between the coil pattern P108 and the coil patterns P111, P112.

Additionally, between the L5 layer (FIG. 7) and the L6 layer (FIG. 8), an interlayer connection made between an end E′ and an end E results in an interlayer connection being established between the coil pattern P109 and the coil pattern P113, an interlayer connection made between an end O and an end O′ results in an interlayer connection being established between the coil pattern P110 and the coil pattern P114, an interlayer connection made between an end b′ and an end b results in an interlayer connection being established between the coil pattern P111 and the coil pattern P115, and an interlayer connection made between an end e and an end e′ results in an interlayer connection being established between the coil pattern P112 and the coil pattern P116.

Additionally, between the L6 layer (FIG. 8) and the L7 layer (FIG. 9), an interlayer connection made between an end D′ and an end D results in an interlayer connection being established between the coil pattern P113 and the coil pattern P117, an interlayer connection made between an end P and an end P′ results in an interlayer connection being established between the coil pattern P114 and the coil pattern P118, an interlayer connection made between an end a′ and an end a results in an interlayer connection being established between the coil pattern P115 and the coil pattern P119, and an interlayer connection made between an end f and an end f′ results in an interlayer connection being established between the coil pattern P116 and the coil pattern P120.

Additionally, between the L7 layer (FIG. 9) and the L8 layer (FIG. 10), an interlayer connection made between an end C′ and an end C results in an interlayer connection being established between the coil pattern P117 and the coil pattern P121, and an interlayer connection made between an end Q and an end Q′ results in an interlayer connection being established between the coil pattern P118 and the coil pattern P122.

Additionally, between the L8 layer (FIG. 10) and the L9 layer (FIG. 11), an interlayer connection made between an end B′ and an end B results in an interlayer connection being established between the coil pattern P121 and the coil pattern P123, and an interlayer connection made between an end R and an end R′ results in an interlayer connection being established between the coil pattern P122 and the coil pattern P124.

Additionally, between the L9 layer (FIG. 11) and the L10 layer (FIG. 12), an interlayer connection made between an end A′ and an end A results in an interlayer connection being established between the coil pattern P123 and the coil pattern P125, and an interlayer connection made between an end S and an end S′ results in an interlayer connection being established between the coil pattern P124 and the coil pattern P126.

The interlayer connections established between respective pairs of the coil patterns P108, P111, P115, and P119 form a first primary coil C1 being wound spirally in convolutions in the Z-direction in the coil lamination 10. Additionally, the interlayer connections established between respective pairs of the coil patterns P108, P112, P116, and P120 form a second primary coil C1 being wound spirally in convolutions in the Z-direction in the coil lamination 10.

Additionally, the interlayer connections established between respective pairs of the coil patterns P101, P102, P104, P106, P109, P113, P117, P121, P123, and P125 form a first secondary coil C2 being wound spirally in convolutions in the Z-direction in the coil lamination 10. Additionally, the interlayer connections established between respective pairs of the coil patterns P101, P103, P105, P107, P110, P114, P118, P122, P124, and P126 form a second secondary coil C2 being wound spirally in convolutions in the Z-direction in the coil lamination 10. The first secondary coil C2 is formed inside the first primary coil C1 and the second secondary coil C2 is formed inside the second primary coil C1.

Additionally, stacking of the layers from the L1 layer to the L10 layer one on top of another results in interlayer connections being established between respective pairs of the magnetic patterns P201, P203, P205, P207, P209, P211, P213, P215, P217, and P219 to thereby form the magnetic substance 20 filling the inside of the first secondary coil C2. Additionally, the stacking of the layers from the L1 layer to the L10 layer one on top of another results in interlayer connections being established between respective pairs of the magnetic patterns P202, P204, P206, P208, P210, P212, P214, P216, P218, and P220 to thereby form the magnetic substance 20 filling the inside of the second secondary coil C2. Additionally, the stacking of the layers from the L1 layer to the L10 layer one on top of another results in interlayer connections being established between respective pairs of the non-magnetic patterns P301, P302, P303, P304, P305, P306, P307, P308, P309, and P310 to thereby form in the coil lamination 10 the non-magnetic substance 25 filling the regions excepting the primary coil C1, the secondary coil C2, and the magnetic substance 20.

Then, the magnetic substance layer 15-1, the print pattern layers L1 to L10 formed by screen printing as described above, and the magnetic substance layer 15-2 are stacked one on top of another and are subjected to low temperature sintering at a predetermined temperature (e.g., 850 to 950° C. at which silver does not dissolve, whereby the laminated transformer 1 is manufactured.

Specifically, screen printing processes are repeatedly performed to form the coil patterns, magnetic patterns, and non-magnetic patterns described above and these patterns are stacked on the magnetic substance layer 15-1, whereby the coil lamination 10 is formed on the magnetic substance layer 15-1.

The manufacturing of the laminated transformer 1 through the printing of the coil patterns, magnetic patterns, and non-magnetic patterns as described above enables efficient manufacturing of a laminated transformer that has a strong coupling between the primary coil and the secondary coil.

The present disclosure enables a laminated transformer that has a strong coupling between a primary coil and a secondary coil to be provided.

Although the present disclosure has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A laminated transformer comprising:
a magnetic substance layer;
a coil lamination stacked on the magnetic substance layer, the coil lamination having formed thereinside a primary coil and a secondary coil, the primary coil being wound spirally in convolutions in a stacking direction, the secondary coil being wound spirally in convolutions in the stacking direction and formed inside the primary coil;
a magnetic substance filling inside of the secondary coil in the coil lamination; and
a non-magnetic substance filling a region between the primary coil and the secondary coil and filling outside of the primary coil in the coil lamination.

2. The laminated transformer according to claim 1, wherein
the coil lamination comprises a plurality of print pattern layers including first coil patterns representing the primary coil and second coil patterns representing the secondary coil, the second coil patterns being printed inside the first coil patterns, and
at least one of the print pattern layers includes two first coil patterns and two second coil patterns.

3. A method for manufacturing a laminated transformer, the method comprising:
a step of printing to form print pattern layers by screen printing first coil patterns representing a primary coil, second coil patterns representing a secondary coil, and magnetic patterns;
a step of forming a coil lamination including the print pattern layers that are stacked one on top of another through the screen printing performed repeatedly; and
a step of stacking the coil lamination on a magnetic substance layer, wherein
the step of printing includes, in the print pattern layers, screen printing of the magnetic patterns formed in regions inside the second coil patterns, screen printing of non-magnetic patterns formed in regions between the first coil patterns and the second coil patterns, and screen printing of the non-magnetic patterns formed outside the first coil patterns, and
the step of forming of the coil lamination includes:
forming of the primary coil being wound spirally in convolutions in a stacking direction, through an interlayer connection made between the first coil patterns;
forming of the secondary coil being wound spirally in convolutions in the stacking direction inside the primary coil, through an interlayer connection made between the second coil patterns;
forming of a magnetic substance filling inside of the secondary coil through an interlayer connection made between the magnetic patterns; and
forming of a non-magnetic substance filling a region between the primary coil and the secondary coil and filling outside of the primary coil through an interlayer connection made between the non-magnetic patterns.
